(19) United States
(12) Patent Application Publication
(10) Pub. No.: US 2011/0146197 A1
(43) Pub. Date: Jun. 23, 2011

(54) TAB CUTTING APPARATUS FOR USE IN FLOOR LEVELING

(76) Inventor: Thomas H. Tedford, Glendale, AZ (US)

(21) Appl. No.: 12/643,322

(22) Filed: Dec. 21, 2009

(51) Int. Cl. E04F 21/00; E04B 5/00; B26D 5/00

(52) U.S. Cl. 52/745.05; 52/749.1; 52/750; 83/363

(57) ABSTRACT

Tab cutting apparatus designed to assist in floor leveling, the tab cutting apparatus including a base designed for movement along the surface of a floor. A framework is affixed to the base and supports a vertically movable portion above the base. The framework and vertically movable portion include height control apparatus capable of moving the movable portion vertically relative to the framework. Height sensing apparatus is affixed to the movable portion. A cutting element is affixed to the movable portion and positioned at a fixed distance below the height sensing apparatus. The cutting element is designed to cut an upright ribbon or rod portion of a leveling tab.

### FIELD OF THE INVENTION

This invention relates to apparatus used in a floor leveling process.

More particularly, the present invention relates to tab cutting apparatus used in leveling concrete floors and the like.

### BACKGROUND OF THE INVENTION

In the field of providing solid floors, such as concrete floors and the like, it is well known that relatively large variations in the surface height can occur. In many instances it is highly desirable to have a flat surface that is substantially level. For example, many flooring manufacturers require ⅛″ or less in 10 ft. deviation in height to install certain types of wood laminate and travertine type surfaces.

To provide a substantially level floor it is common practice to place small upright markers or tabs on the floor at regular intervals or in a pre-formed grid that covers the entire floor. Workers then determine a desirable height and cut each tab so that it extends to that height. This process is very time consuming and requires a great amount of effort. Once the tabs are all trimmed to the desired or common height, an over-layer of self-leveling engineered cement or similar substance is poured and smoothed so that it reaches to the top of the trimmed tabs.

It would be highly advantageous, therefore, to remedy the foregoing and other deficiencies inherent in the prior art.

An object of the present invention is to provide new and improved tab cutting apparatus for use in floor leveling.

Another object of the present invention is to provide new and improved tab cutting apparatus that is operated to quickly and easily measure and trim floor leveling tabs to a specific height.

Another object of the present invention is to provide new and improved tab cutting apparatus that is easy and efficient to use.

### SUMMARY OF THE INVENTION

The objects and advantages of the present invention are realized in tab cutting apparatus designed to assist in floor leveling. The tab cutting apparatus includes a base designed for movement along the surface of a floor. A framework is affixed to the base and supports a vertically movable portion above the base. The framework and vertically movable portion include height control apparatus capable of moving the movable portion vertically relative to the framework. Height sensing apparatus is affixed to the movable portion. A cutting element is affixed to the movable portion and positioned at a fixed distance below the height sensing apparatus. The cutting element is designed to cut an upright ribbon or rod of a leveling tab.

The objects and advantages of the present invention are further realized in a method of leveling floors including the step of providing tab cutting apparatus including a base designed for movement along the surface of a floor, a framework affixed to the base and supporting a vertically movable portion above the base, the framework and vertically movable portion including height control apparatus capable of moving the movable portion vertically relative to the framework, light beam sensing apparatus affixed to the movable portion, and a cutting element affixed to the movable portion and positioned at a fixed distance below the light beam sensing apparatus, the cutting element being designed to cut an upright rod of a leveling tab. The method further includes a step of providing a light source generating a beam of light and positioning the light source adjacent to a floor to be leveled. The light source is further positioned to direct the beam of light in a plane parallel to and spaced a known height above a desired surface height of the floor. A plurality of leveling tabs are positioned on the floor in a spaced apart orientation. The tab cutting apparatus is moved over the floor and into a tab cutting position relative to each leveling tab of the plurality of leveling tabs. The height control apparatus of the tab cutting apparatus is operated at each leveling tab of the plurality of leveling tabs to align the beam of light with the light beam sensing apparatus. The cutting element is then operated to cut each leveling tab of the plurality of leveling tabs when the light beam sensing apparatus is aligned with the beam of light at each leveling tab of the plurality of leveling tabs. Finally, a layer of material is positioned on the floor with the surface of the material limited to include an upper end of each of the plurality of leveling tabs.

The objects and advantages of the present invention are further realized in a leveling tab designed to assist in floor leveling. The leveling tab in accordance with the present invention includes a base having a sticky lower surface, and an upright rod with a circular cross-section affixed in a vertical orientation to an upper surface of the base.

### BRIEF DESCRIPTION OF THE DRAWINGS

Specific objects and advantages of the instant invention will become readily apparent to those skilled in the art from the following detailed description of a preferred embodiment thereof taken in conjunction with the drawings, in which:

FIG. 1 is a top plan view of a floor that is to be leveled, illustrating leveling equipment in a semi-schematic form;

FIG. 2 is a top perspective view of the floor of FIG. 1;

FIG. 2A is a top perspective view of the floor similar to FIG. 2, illustrating the leveling equipment in more detail;

FIGS. 4, 5, and 6 are perspective, front, and side views, respectively, of tab cutting apparatus for use in floor leveling in accordance with the present invention;

FIG. 7 is an enlarged perspective view of an upper portion of the floor leveling apparatus of FIG. 4;

FIG. 8 is an enlarged perspective view of a lower portion of the tab cutting apparatus of FIG. 4;

FIG. 9 is an enlarged perspective view of the lower portion of the tab cutting apparatus of FIG. 4 in a tab trimming orientation;

FIG. 9A is an enlarged perspective view of a lower portion of another embodiment of the tab cutting apparatus of FIG. 4;

FIG. 10 is a perspective view of a new and improved floor tab, in accordance with the present invention; and

FIG. 11 is a perspective view of another embodiment of tab cutting apparatus for use in floor leveling in accordance with the present invention.

### DETAILED DESCRIPTION OF THE DRAWINGS

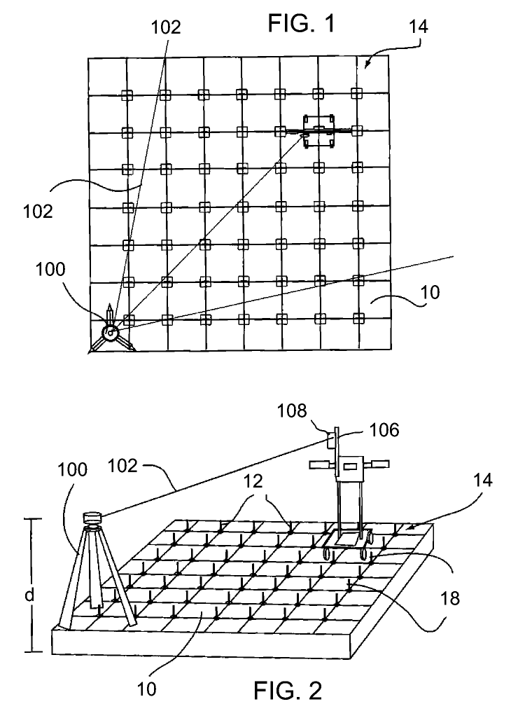

Turning now to FIGS. 1-3, a floor 10 is illustrated having leveling tabs 12 positioned thereon. For convenience in understanding the floor leveling process, a floor is illustrated as a first or supporting layer 10 prior to receiving a leveling layer thereover. Leveling tabs 12 are pre-positioned on the upper surface of supporting layer 10 manually by first dividing or demarking the surface of supporting layer 10 into regularly spaced lines to form an overlying grid or matrix 14. Generally, grid or matrix 14 forms a plurality of orthogonal columns and rows with a leveling tab 12 positioned at each crossing. It will be understood that grid or matrix 14 can be provided in any desired shape or pattern that can best be used to finally level the specific supporting layer 10 and any specific grid or matrix is not a part of this invention.

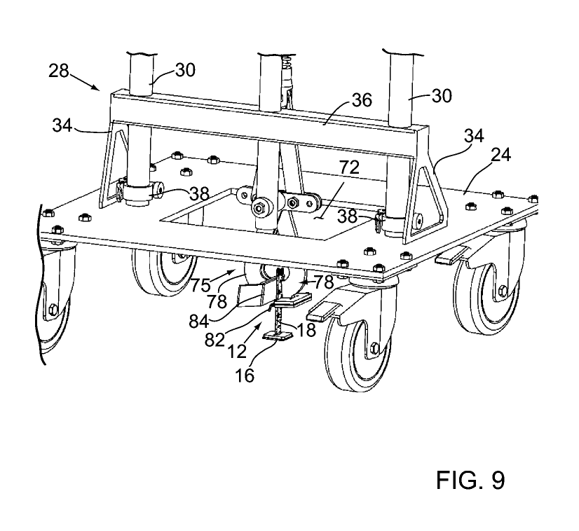

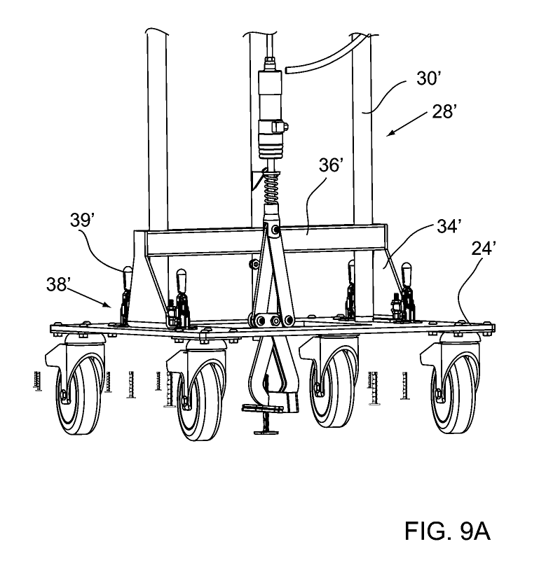

Referring briefly to FIG. 9, a leveling tab 12 is illustrated including a base 16 and an upright tab 18. In this embodiment tab 18 is a stiff but flexible ribbon-like element, generally formed of plastic, with flat sides that must be cut in the plane of the ribbon-like element (i.e. parallel to the flat surface). In a preferred embodiment illustrated in FIG. 10, a leveling tab 12′ includes a very thin base 16′ having a sticky lower surface (e.g. double backed tape, contact cement, or any adhesive that will stick on contact with the floor) and an upright rod or stick portion 18′, with a generally circular cross-section, fixedly attached to base 16′. In this preferred embodiment, leveling tab 12′ includes generally arcuate indentations 19′ extending the length of rod portion 18′ and forming generally opposed sides or a cross-like cross-section. Indentations 19′ reduce the amount of material that must be cut while maintaining the stiffness and flexibility. Rod 18′ of tab 12′ should be flexible to allow the convenient movement of tab cutting apparatus across supporting layer 10. Because of the circular cross-section with cross-like indentations, rod portion 18′ of tab 12′ can be easily cut from any direction. It will of course be understood that other cross-sections for rod 18′ might be devised but a basic round cross-section with some material removed to enhance cutting is generally preferred.

Upright rod or stick portion 18′ serves as a height indicator, as will be described in detail below, and may be any stiff easily cuttable material, such as plastic, paper, wood, etc., and preferably has a round cross-section, as explained above. While leveling tabs 12′ are preferred it will be apparent from the description below that either leveling tabs 12 or leveling tabs 12′ could be used with the novel tab cutting apparatus described below but leveling tabs 12′ provide the advantage of being cuttable from any direction. Leveling tabs 12′ might be formed in a variety of different embodiments and shapes and, for convenience will simply be referred to as ‘leveling tabs’ hereinafter. Leveling tabs 12′ are generally formed as cheaply as possible since they will be permanently included in the floor and do not provide any support or component of the structure.

Once supporting layer 10 is divided into the desired overlying grid, pattern, or matrix 14, leveling tabs 12′ are placed at selected junctions or cross-points as illustrated in FIGS. 1-3. Generally, laying out the desired overlying grid, pattern, or matrix 14 and placing leveling tabs 12′ at the junctions or cross-points is relatively fast and simple. In all known leveling processes, each tab 12 has to be measured, relative to a standard or desired height and trimmed manually to the desired height from a specific direction. This tab trimming process is very time consuming and difficult, and is subject to many errors.

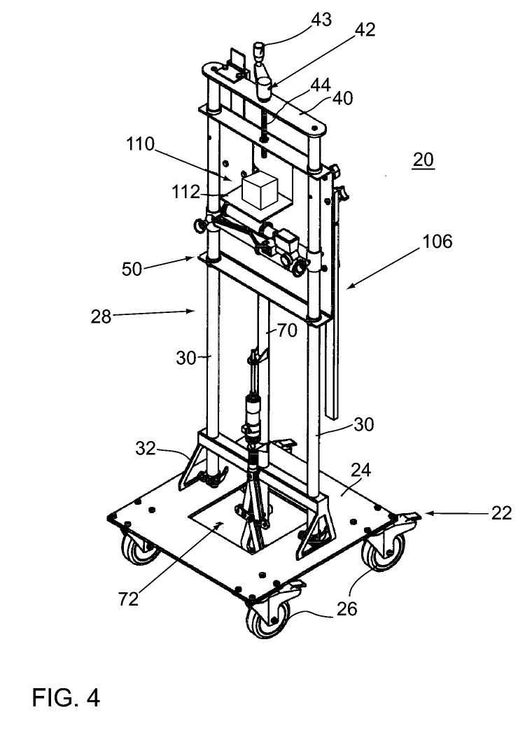

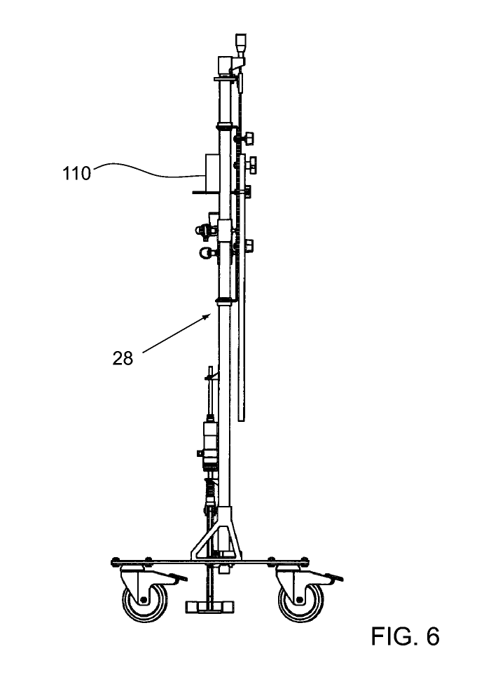

In accordance with the present invention, tab cutting apparatus, generally designated 20, is provided. Turning specifically to FIGS. 4-6, tab cutting apparatus 20 is illustrated. Apparatus 20 includes a dolly 22 with a base 24 and a plurality (in this specific embodiment four) of castors or wheels 26 affixed to the underside thereof. A framework, generally designated 28, includes a pair of elongated mounting rods 30 affixed vertically on the upper surface of base 24 and extending upwardly in a parallel spaced apart orientation. While a variety of different structures might be used to affix rods 30 to base 24, in this embodiment a mounting structure 32 holds and affixes the lower ends to the upper surface of base 24. Mounting structure 32 includes a pair of triangular elements 34 having one side affixed to the upper surface of base 24, by welding or the like, and an elongated guide 36 extending between the apex or upper ends of the triangular elements 34. Rods 30 extend from base 24 upwardly through openings in guide 36 with the lower ends affixed to the upper surface of base 24 by clamps 38 (Best illustrated in FIG. 9). It will be understood that rods 30 could be permanently attached to base 24 by welding or the like but the present structure allows for dismantling and storing.

Another embodiment for attaching framework 28 to base 24 is illustrated in FIG. 9A. In this embodiment, triangular elements 34′ and elongated guide 36′ are affixed together into one piece. Each triangular element 34′ includes a support member positioned flat on the surface of base 24′ and the lower ends of rods 30′ are permanently affixed to a the support members of each of triangular elements 34′ through guide 36′. The support members of each of triangular elements 34′ are removably affixed to base 24′ by means of clamps 38′. Clamps 38′ are bolted or otherwise affixed to base 24′ and include handles 39′ that in a convenient over-center or camming action fixedly hold the support members of each of triangular elements 34′ in position on the surface of base 24′. More specifically, the present structure separates into two pieces for transportation and storage, with the wheels and base being a separate component.

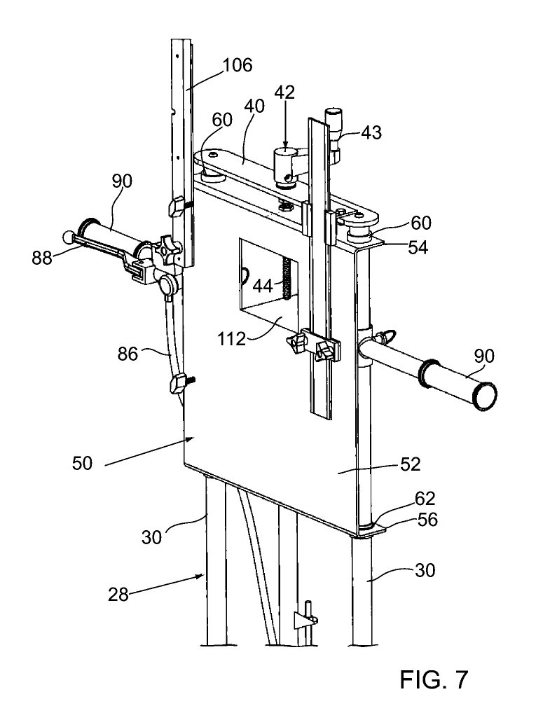

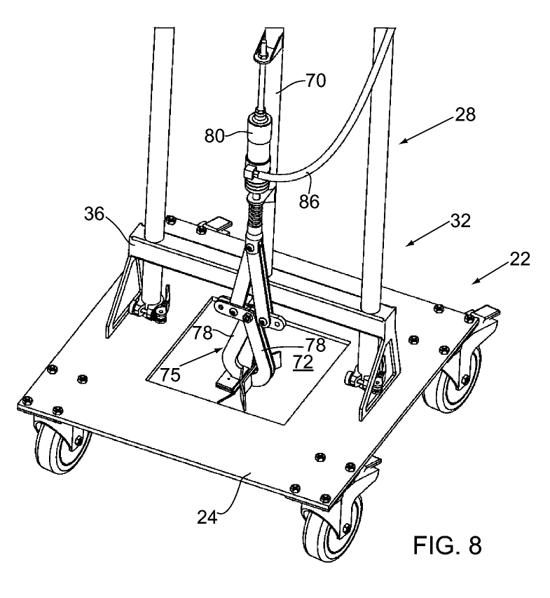

The upper ends of rods 30 are attached together by a cross-bar 40 that may be permanently or removably affixed between the upper ends to form a mounting surface for height control apparatus 42. In this specific embodiment, height control apparatus 42 includes a manual crank 43 affixed to one end of an elongated screw element 44 (best seen in FIG. 7). Screw element 44 is rotatably mounted approximately centrally within crossbar 40 so as to extend downwardly a substantial distance between rods 30 and parallel thereto. Screw element 44 is rotatably mounted by some convenient apparatus, such as a bearing or the like for rotation in response to turning of crank 43. It will be understood that height control apparatus 42 could include different structure for adjusting height and could include an electric or pneumatic motor or the like.

A vertically movable carriage 50 is slideably engaged with rods 30 for vertical movement therealong. In this specific embodiment, carriage 50 includes a generally rectangular face plate 52 with right-angle flanges 54 and 56 formed at the upper and lower edges, respectively, thereof. A pair of openings 60 are formed through upper flange 54 at opposite ends thereof and in alignment with similar openings 62 in lower flange 56. Carriage 50 is mounted for vertical movement by extending rods 30 through openings 60 and 62. Sleeve bearings or the like may be positioned in openings 60 and 62, if desired, to ensure smooth vertical movement of carriage 50 along rods 30.

A central opening is provided through upper flange 54 and a follower nut 64 is coaxially affixed in the opening. Screw element 44 is threadedly engaged through follower nut 64 so that carriage 50 is moved vertically up and down as crank 43 is manually rotated clockwise or counter-clockwise. Screw element 44 is provided because rotation thereof allows for very small and accurate adjustment of height. While this manual control is illustrated because it is believed to be the most reliable, simplest and least expensive to provide, it will be understood that other height control apparatus, such as electric motors, etc. might be provided if desired.

A mounting rod 70 is centrally affixed to lower flange 56 of carriage 50 and extends downwardly through a central opening in elongated guide 36 and through an opening 72 in the center of base 24 of dolly 22. Mounting rod 70 is affixed to carriage 50 for vertical movements therewith. A cutting element 75 is affixed to the lower end of mounting rod 70 and is positioned and mounted to engage and cut the upright ribbon 18 of leveling tabs 12 or the upright circular rod 18′ of leveling tabs 12′. In this embodiment cutting element 75 includes a pair of jaws 78 mounted for reciprocal cutting movements in response to operation of a hydraulic cylinder 80. One jaw 78 has a sharp blade 82 attached thereto and the opposite jaw 78 has an anvil 84 associated with blade 82 attached thereto to form a cutting device. When hydraulic cylinder 80 is actuated blade 82 and anvil 84 are moved together by jaws 78 to provide an efficient cutting action. It will be understood that other cutting elements (e.g. scissors, clippers, etc.) may be provided if desired and the blade and anvil described herein is simply one example.

Hydraulic cylinder 80 is operatively attached through a fluid conduit 86 to an actuating lever 88 mounted on one control handle of a pair of control handles 90 fixedly attached, one each, to mounting rods 30. Control handles 90 are provided so that an operator can quickly and easily position dolly 22 over each leveling tab 12 or 12′ with the upright ribbon 18 or rod 18′ of the selected leveling tab 12 or 12′ positioned between blade 82 and anvil 84. Carriage 50 is then moved vertically by rotating crank 43 so that cutting element 75 is at the desired height (explained in detail below) and actuating lever 88 is operated to cut the upright ribbon 18 or rod 18′ of the selected leveling tab 12 or 12′. It will be understood that hydraulic operation of cutting element 75 could be replaced with electrically or mechanically operated elements if desired.

In the operation of tab cutting apparatus 20, an elevated rotating laser 100 or similar apparatus is positioned at some point on the floor deemed to be at the desired floor height (see FIGS. 1-3). It will be understood that suitable rotating lasers are presently used in contracting work and are well known in the art. Also, while any collimated light source might be used, a laser is preferred for its highly directional beam and for its commercial availability. If desired such a tool can be easily constructed by simply providing any commercially available laser and mounting it on a suitable base that can be easily adjusted to place the laser at any selected height above a desired floor height. The laser of rotating laser 100 is positioned to direct a beam, indicated by arrow 102, outwardly at a height d (indicated by arrows in FIG. 3) above a desired floor height, indicated by a broken line 104 in FIG. 3. The laser can then be automatically rotated or simply moved manually as needed.

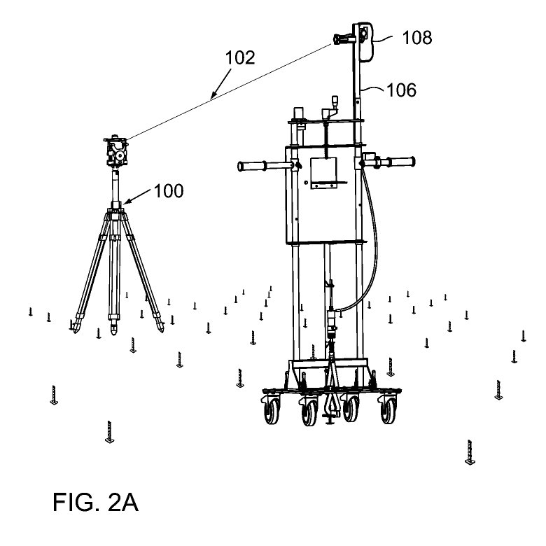

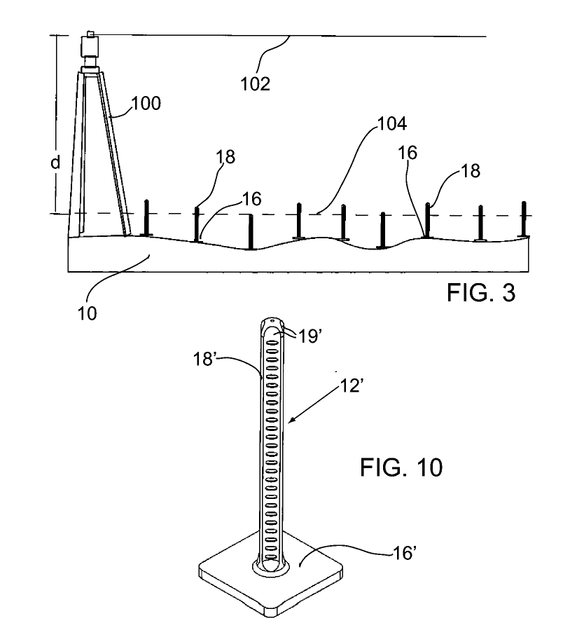

In this specific embodiment, sensing apparatus 110 of tab cutting apparatus 20 includes a vertically movable arm 106 affixed in vertical orientation to face plate 52 of carriage 50. It should be understood that arm 106 may be vertically movable, rotatable or simply fixed in place. A laser target or sensor 108 is provided on arm 106 (see FIGS. 2 and 2A) that is a fixed distance above the cutting plane of cutting element 75. Generally, the fixed distance will be the same as height d of rotating laser 100. Once tab cutting apparatus 20 is correctly positioned relative to a selected leveling tab 12 or 12′, the operator rotates crank 43 until laser beam 102 is vertically aligned with sensor 108 of arm 106. The operator then moves actuating lever 88 until cutting element 75 cuts or severs upright ribbon 18 or rod 18′ of the selected leveling tab 12 or 12′. The height of upright ribbon 18 or rod 18′ of the selected leveling tab 12 or 12′ is then precisely the desired height of the floor. The operator then moves on to the next leveling tab 12 or 12′. When leveling tabs 12′ are used the direction in which the operator approaches leveling tab 12′ with cutting apparatus 20 is not critical and thus saves the additional movements required to align the cutter with the upright ribbon 18 of leveling tab 12.

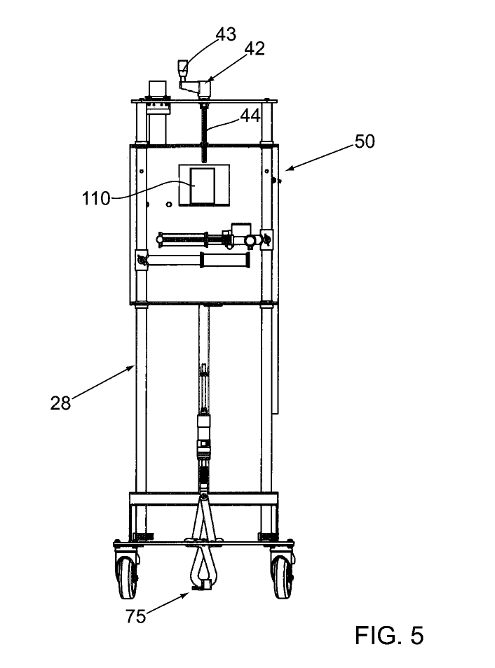

While arm 106 and laser target or sensor 108 are provided in this specific embodiment, it should be understood that other sensing apparatus 110 might be used in conjunction with rotating laser 100, such as a laser sensor that would provide an indication (e.g. bell, light, or other signal) when it is correctly aligned with laser beam 102. Sensing apparatus of this type could be mounted on flange or platform 112 provided for this purpose (see FIGS. 4 and 5). Platform 112 is formed by simply cutting a portion of faceplate 52 along three sides and bending the portion ninety degrees to faceplate 52.

A vertically movable ruler or measuring stick 120 is attached to face plate 52 of carriage 50 in a conveniently observable position. Ruler 120 is used as a base elevation or zero indicator in applications where the operator wishes to add a gradual slope to the floor leveling compound.

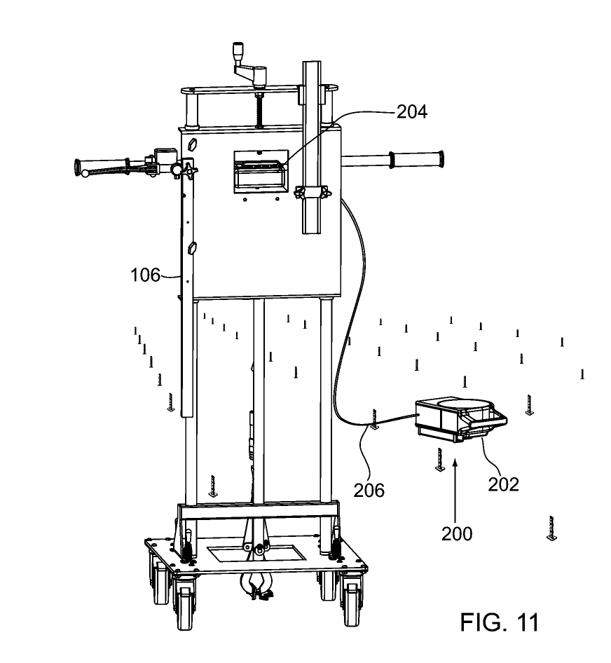

In another embodiment of sensing apparatus, a high pressure silicon altimeter system 200 is illustrated in FIG. 11. High pressure silicon altimeter system 200 is well known in the art and will not be described in detail except for the following brief description. System 200 includes a zero floor sensor 202 which is designed to be positioned on the surface of supporting layer 10 at some point on the floor deemed to be at the desired floor height (zero position). A pressure sensor 204 is carried at some convenient location (e.g. platform 112) on movable carriage 50. Pressure sensor 204 is pressure coupled to zero floor sensor 202 by a tubular coupler 206. Tubular coupler 206 will be at least long enough to move tab cutting apparatus 20 across the entire supporting layer 10 preferably without moving zero floor sensor 202. As will be understood, as movable carriage 50 is moved vertically by rotating height control apparatus 42 (manual crank 43) pressure sensor 204 moves vertically relative to supporting layer 10. Pressure sensor 204 is calibrated to indicate in some convenient fashion when it is positioned exactly the height d above zero floor sensor 202 positioned on the surface of supporting layer 10.

When the upright ribbons 18 or rods 18′ of all of leveling tabs 12 or 12′ in matrix or grid 14 are the correct height, a second layer of concrete or other substance (e.g. engineered self-leveling cement or Gro-Crete) being used (indicated by broken line 104 in FIG. 3)) is poured over the upper surface of supporting layer 10 and leveled or smoothed to the height of the upright ribbon 18 or rod 18′ of each leveling tab 12 or 12′. Thus the second layer will be substantially or virtually level across its entire surface. As will be understood from the above description, the entire process and leveling apparatus is simple, extremely accurate and very fast compared to prior art processes and apparatus.

While the present tab cutting apparatus 20 is described primarily as apparatus for use in leveling floors, it should be understood that it can also be used in other functions, such as for providing initial material estimations and general surveying of any existing concrete substrates. This is true of either the laser operated device or the high pressure silicon altimeter embodiment.

Various changes and modifications to the embodiments herein chosen for purposes of illustration will readily occur to those skilled in the art. To the extent that such modifications and variations do not depart from the spirit of the invention, they are intended to be included within the scope thereof, which is assessed only by a fair interpretation of the following claims.

Having fully described the invention in such clear and concise terms as to enable those skilled in the art to understand and practice the same, the invention claimed is:

1. Tab cutting apparatus designed to assist in floor leveling, the tab cutting apparatus comprising:
a base designed for movement along the surface of a floor;
a framework affixed to the base and supporting a vertically movable portion above the base, the framework and vertically movable portion including height control apparatus capable of moving the movable portion vertically relative to the framework;
height sensing apparatus affixed to the movable portion; and
a cutting element affixed to the movable portion and positioned at a fixed distance below the height sensing apparatus, the cutting element being designed to cut an upright portion of a leveling tab.

2. Tab cutting apparatus as claimed in claim 1 wherein the base includes a plurality of wheels affixed to allow movement along the surface of a floor.

3. Tab cutting apparatus as claimed in claim 1 wherein the framework includes a plurality of upright elongated elements, each elongated element having a lower end affixed to the base with the remainder of each elongated element extending upwardly from the base, the plurality of elongated elements being in a generally parallel spaced apart orientation.

4. Tab cutting apparatus as claimed in claim 3 wherein the vertically movable portion includes a carriage slideably engaged with the plurality of upright elongated elements so as to be vertically movable along the plurality of elongated elements relative to the base.

5. Tab cutting apparatus as claimed in claim 4 wherein the height control apparatus includes a crank rotatably mounted on the framework and an associated screw engaged with the carriage so as to move the carriage vertically in response to rotation of the screw.

6. Tab cutting apparatus as claimed in claim 1 wherein the height sensing apparatus includes a laser positionable at a desired height above a floor.

7. Tab cutting apparatus as claimed in claim 6 wherein the height sensing apparatus further includes a marker or target positioned on the movable portion so as to receive a light beam from the laser when the movable portion is positioned at a desired height above a floor.

8. Tab cutting apparatus as claimed in claim 1 wherein the height sensing apparatus includes a high pressure silicon altimeter system with a pressure sensor positioned on the movable portion and pressure coupled to a zero floor sensor positionable at a desired height above a floor.

9. A method of leveling floors comprising the steps of:
providing tab cutting apparatus including a base designed for movement along the surface of a floor, a framework affixed to the base and supporting a vertically movable portion above the base, the framework and vertically movable portion including height control apparatus capable of moving the movable portion vertically relative to the framework, light beam sensing apparatus affixed to the movable portion, and a cutting element affixed to the movable portion and positioned at a fixed distance below the light beam sensing apparatus, the cutting element being designed to cut an upright rod of a leveling tab;
providing a light source generating a beam of light and positioning the light source adjacent to a floor to be leveled, the light source being further positioned to direct the beam of light in a plane parallel to and spaced a known height above a desired surface height of the floor;
positioning a plurality of leveling tabs on the floor in a spaced apart orientation;
moving the tab cutting apparatus over the floor and into a tab cutting position relative to each leveling tab of the plurality of leveling tabs;
operating the height control apparatus of the tab cutting apparatus at each leveling tab of the plurality of leveling tabs to align the beam of light with the light beam sensing apparatus;
operating the cutting element to cut each leveling tab of the plurality of leveling tabs when the light beam sensing apparatus is aligned with the beam of light at each leveling tab of the plurality of leveling tabs; and
positioning a layer of material on the floor with a surface limited to include an upper end of each of the plurality of leveling tabs.

10. A method as claimed in claim 9 wherein the step of providing a light source includes providing a laser leveling device.

11. A method as claimed in claim 9 wherein the step of positioning the plurality of leveling tabs includes dividing the surface of the floor into regularly spaced lines to form an overlying grid and placing one leveling tab of the plurality of leveling tabs on each line intersection in the grid.

12. A method as claimed in claim 9 wherein the step of positioning the plurality of leveling tabs includes placing leveling tabs each having a base and an upright rod with a circular cross-section.

13. A method of leveling floors comprising the steps of:
providing tab cutting apparatus including a base designed for movement along the surface of a floor, a framework affixed to the base and supporting a vertically movable portion above the base, the framework and vertically movable portion including height control apparatus capable of moving the movable portion vertically relative to the framework, and a cutting element designed to cut an upright rod portion of a leveling tab;
providing a high pressure silicon altimeter system including a pressure sensor positioned on the movable portion of the tab cutting apparatus and a zero floor sensor pressure coupled to the pressure sensor, the cutting element of the tab cutting apparatus affixed to the movable portion and positioned at a fixed distance below the pressure sensor;
positioning the zero floor sensor at a desired height above a floor to be leveled;
positioning a plurality of leveling tabs on the floor in a spaced apart orientation;
moving the tab cutting apparatus over the floor and into a tab cutting position relative to each leveling tab of the plurality of leveling tabs;
operating the height control apparatus of the tab cutting apparatus at each leveling tab of the plurality of leveling tabs to align the pressure sensor with the zero floor sensor; and
operating the cutting element to cut each leveling tab of the plurality of leveling tabs when the pressure sensor is aligned with the zero floor sensor at each leveling tab of the plurality of leveling tabs.

14. A method as claimed in claim 13 subsequent to the step of operating the cutting element to cut each leveling tab, further including a step of positioning a layer of material on the floor with a surface limited to include an upper end of each of the plurality of leveling tabs.

15. A method as claimed in claim 13 wherein the step of positioning the plurality of leveling tabs includes dividing the surface of the floor into regularly spaced lines to form an overlying grid and placing one leveling tab of the plurality of leveling tabs on each line intersection in the grid.

16. A method as claimed in claim 13 wherein the step of positioning the plurality of leveling tabs includes placing leveling tabs each having a base and an upright rod with a generally round cross-section.

17. A leveling tab designed to assist in floor leveling, the leveling tab comprising a base having a sticky lower surface, and an upright rod with a circular cross-section affixed in a vertical orientation to an upper surface of the base.

18. A leveling tab as claimed in claim 17 wherein the upright rod has longitudinally extending depressions formed therein to reduce the material of a cross-section and enhance cutting.

19. A leveling tab as claimed in claim 17 wherein the upright rod has longitudinally extending depressions formed therein to define a generally cross-shaped cross-section.

20. A leveling tab as claimed in claim 17 wherein the upright rod includes one of plastic, paper, and wood.
